(19) United States
(12) Patent Application Publication
(10) Pub. No.: US 2010/0070853 A1
(43) Pub. Date: Mar. 18, 2010

(54) METHOD AND APPARATUS FOR DISPLAYING IMAGES IN AN OUTLINE VIEW OF A DOCUMENT

(75) Inventor: Scott D. Holdaway, Portland, OR (US)

Correspondence Address: PVF -- APPLE INC.;c/o PARK, VAUGHAN & FLEMING LLP, 2820 FIFTH STREET, DAVIS, CA, 95618-7759, US

(73) Assignee: APPLE INC., Cupertino, CA (US)

(21) Appl. No.: 12/210,871

(22) Filed: Sep. 15, 2008

(51) Int. Cl. G06F 3/14

(52) U.S. Cl. 715/243

(57) ABSTRACT

One embodiment of the present invention provides a system that facilitates displaying images in an outline view of an electronic document. During operation, the system receives a command from a user to display an electronic document in an outline view. In response to the command, the system determines a location of an image in the electronic document relative to a nearby character in the electronic document by treating the image as if the image were an inline character. Finally, the system creates the outline view of the electronic document by: placing the image as an inline character in the outline view in a new location that has a same relative location to the nearby character; determining if the image is too large to fit in the new location; and if so, temporarily scaling the image to fit in the new location.

### BACKGROUND

1. Field of the Invention

The present invention relates to tools for editing and viewing electronic documents. More specifically, the present invention relates to a method and an apparatus that facilitates displaying images in an outline view of a document.

2. Related Art

Word-processing applications typically allow a user to view an electronic document using different views, such as: a What-You-See-Is-What-You-Get (WYSIWYG) view, a standard view, a page-layout view, a notebook-layout view, and an outline view. Each of these views can assist the user in performing different tasks.

One such view, the outline view, provides a user with a quick look at the structure of an electronic document which enables the user to quickly alter the structure of the electronic document. In a typical outline view, the electronic document is organized as a single outline, wherein the indentation level of items in the outline represents different structural elements of the electronic document. Because the outline is intended to show the structure of the electronic document in a format that enables a user to quickly alter the structure, only enough content as is necessary to convey the structure is shown to the user, and display of the remaining content is suppressed.

For example, consider a paragraph in the electronic document that has 10 sentences and occupies 15 lines when the electronic document is displayed in a standard view. When the user views the same electronic document in the outline view, typically only the first line of the paragraph is displayed, including an ellipses which indicates that there is more content associated with the paragraph that has been suppressed. Just enough content is shown for the user to identify the paragraph. When displaying an electronic document in an outline view, items other than text, such as images, are typically omitted.

However, in many cases, the positioning of images within the structure of the electronic document can be very important. For example, a user may wish to quickly rearrange the ordering of pictures scattered throughout the electronic document. Within conventional word processing programs, rearranging pictures is not easily accomplished. For example, a user must locate each picture in the electronic document to remove the picture, and then navigate to the section of the electronic document where the user wishes to move the picture. In electronic documents that have hundreds of pictures and hundreds of pages of content, this can be a very tedious task.

Hence, what is needed is a technique that facilitates easily finding and relocating pictures within an electronic document without the problems listed above.

### SUMMARY

One embodiment of the present invention provides a system that facilitates displaying images in an outline view of an electronic document. During operation, the system receives a command from a user to display an electronic document in an outline view. In response to the command, the system determines a location of an image in the electronic document relative to a nearby character in the electronic document by treating the image as if the image were an inline character. Finally, the system creates the outline view of the electronic document by: placing the image as an inline character in the outline view in a new location that has a same relative location to the nearby character; determining if the image is too large to fit in the new location; and if so, temporarily scaling the image to fit in the new location.

In some embodiments of the present invention, creating the outline view of the electronic document further comprises replacing the image with an icon representing the image,

In some embodiments of the present invention, creating the outline view of the electronic document further comprises replacing the image with a thumbnail of the image.

In some embodiments of the present invention, the system receives a second command from the user to resize the image while the electronic document is displayed in the outline view. In response to the second command, the system resizes the image.

In some embodiments of the present invention, resizing the image involves resizing the image so that the new size of the image persists in other views of the electronic document.

In some embodiments of the present invention, floating images are not displayed in the outline view. Note that a floating image is an image that stays in a fixed position relative to a window displaying the electronic document, and has no fixed position relative to content in the electronic document.

In some embodiments of the present invention, the system determines if the image is configured to have text wrap around the image. If so, the system includes enough of the text to wrap around the image in the outline view, and suppresses the display of the remaining text.

In some embodiments of the present invention, an image can include one of: a picture, a drawing, and a frame of an embedded video.

### BRIEF DESCRIPTION OF THE FIGURES

FIG. 1 illustrates a computing environment in accordance with an embodiment of the present invention.

FIG. 2 illustrates an apparatus in accordance with an embodiment of the present invention.

FIG. 3A illustrates an electronic document in a standard view in accordance with an embodiment of the present invention.

FIG. 3B illustrates an electronic document in an outline view with embedded images in accordance with an embodiment of the present invention.

FIG. 3C illustrates an electronic document in an outline view with thumbnail images in accordance with an embodiment of the present invention.

FIG. 4 presents a flow chart illustrating the process of displaying an image in an electronic document while displaying the electronic document in an outline view in accordance with an embodiment of the present invention.

FIG. 5 presents a flow chart illustrating the process of creating an outline view of an electronic document in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### Overview

One embodiment of the present invention provides a system that facilitates displaying images in an outline view of an electronic document. During operation, the system receives a command from a user to display an electronic document in an outline view. In response to the command, the system determines a location of an image in the electronic document relative to a nearby character in the electronic document by treating the image as if the image were an inline character. Finally, the system creates the outline view of the electronic document by: placing the image as an inline character in the outline view in a new location that has a same relative location to the nearby character; determining if the image is too large to fit in the new location; and if so, temporarily scaling the image to fit in the new location.

For example, in one embodiment of the present invention, if an image is located between two paragraphs in the standard view of the electronic document, the image is placed in the same relative position between the two paragraphs in the outline view of the electronic document. Note that the absolute location of the image may change, because an electronic document in a standard view may comprise 20 pages, but the same electronic document may only comprise five pages in an outline view. However, the relative position of the image to the content should remain the same.

In some embodiments of the present invention, creating the outline view of the electronic document further comprises replacing the image with an icon representing the image.

In some instances, the user is only interested in seeing where the images are located in the electronic document, but not necessarily seeing the images. Note that the icon can convey additional information, such as image size, type, and file name.

In some embodiments of the present invention, creating the outline view of the electronic document further comprises replacing the image with a thumbnail of the image. By replacing the image with a thumbnail of the image, the user can quickly identify the image and its location within the electronic document.

In some embodiments of the present invention, the system receives a second command from the user to resize the image while the electronic document is displayed in the outline view. In response to the second command, the system resizes the image. If a large image is displayed in its actual size within the outline view of the electronic document, the user may wish to reduce the size of the image to be able to view more of the structure of the electronic document on the page. Note that resizing of an image can be as simple as clicking on one corner of the image and dragging the corner of the image until the desired size of the image is achieved.

In some embodiments of the present invention, resizing the image involves resizing the image so that the new size of the image persists in other views of the electronic document.

For example, a user may wish to scan through a hundred page electronic document and resize all of the images to a standard size. This could be accomplished more easily in an outline view wherein the number of pages that the user must navigate has been reduced.

In some embodiments of the present invention, floating images are not displayed in the outline view. Note that a floating image is an image that stays in a fixed position relative to a window displaying the electronic document, and has no fixed position relative to content in the electronic document. For example, some documents will include a floating image in one of the bottom corners of the electronic document, wherein the floating image is a logo for the corporation that created the electronic document. No matter where the user scrolls to in the electronic document, the floating image stays in the same relative location to a window that is displaying the electronic document.

Note that the use of watermark images may persist, or may be omitted, within an outline view of the electronic document. In some embodiments of the present invention, the display or suppression of floating images and watermarks within the outline view of the electronic document is a user-configurable option.

In some embodiments of the present invention, the system determines if the image is configured to have text wrap around the image. If so, the system includes enough of the text to wrap around the image in the outline view, and suppresses the display of the remaining text.

In some embodiments of the present invention, an image can include one of: a picture, a drawing, and a frame of an embedded video. Note that these image types are included for exemplary purposes only. Any type of content typically displayed within a standard view of an electronic document may be displayed in the outline view of the electronic document in the same relative location to the other content.

### Computing Environment

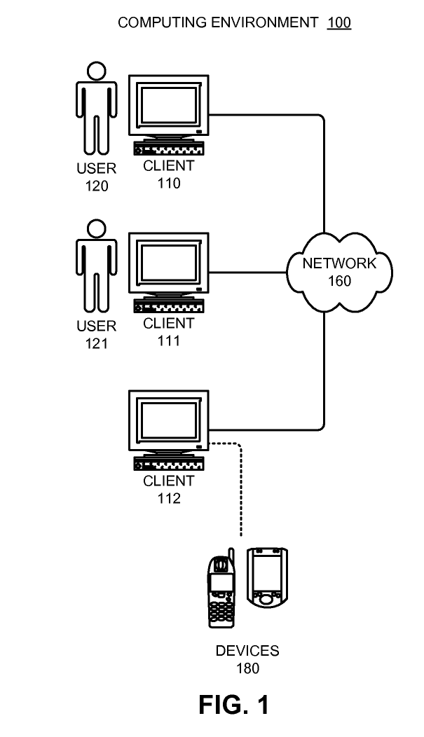

FIG. 1 illustrates a computing environment 100 in accordance with an embodiment of the present invention. Computing environment 100 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 1, computing environment 100 includes clients 110-112, users 120 and 121, network 160, and devices 180.

Clients 110-112 can include any node on a network including computational capability and including a mechanism for communicating across the network. Additionally, clients 110-112 may comprise a tier in an n-tier application architecture, wherein clients 110-112 perform as servers (servicing requests from lower tiers or users), and wherein clients 110-112 perform as clients (forwarding the requests to a higher tier).

Users 120 and 121 can include: an individual; a group of individuals; an organization; a group of organizations; a computing system; a group of computing systems; or any other entity that can interact with computing environment 100.

Network 160 can include any type of wired or wireless communication channel capable of coupling together computing nodes. This includes, but is not limited to, a local area network, a wide area network, or a combination of networks. In one embodiment of the present invention, network 160 includes the Internet. In some embodiments of the present invention, network 160 includes phone and cellular phone networks.

Devices 10 can include any type of electronic device that can be coupled to a client, such as client 112. This includes, but is not limited to, cell phones, personal digital assistants (PDAs), smart-phones, personal music players (such as MP3 players), gaming systems, digital cameras, portable storage media, or any other device that can be coupled to the client. Note that in some embodiments of the present invention, devices 180 can be coupled directly to network 160 and can function in the same manner as clients 110-112.

Note that different embodiments of the present invention may use different system configurations, and are not limited to the system configuration illustrated in computing environment 100.

### Apparatus

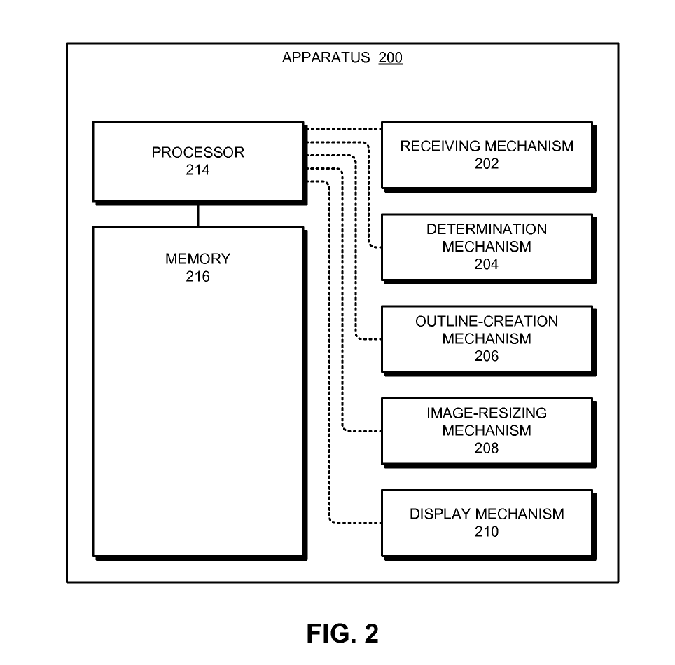

FIG. 2 illustrates an apparatus 200 in accordance with an embodiment of the present invention. Apparatus 200, which can be one of clients 110-112 and devices 180, includes receiving mechanism 202, determination mechanism 204, outline-creation mechanism 206, image-resizing mechanism 208, display mechanism 210, processor 214, and memory 216.

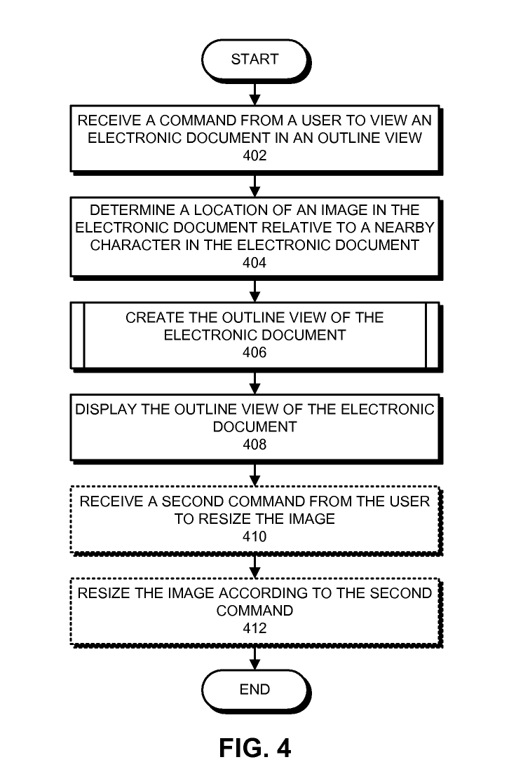

Note that the operation of these mechanisms is described in more detail below in the description of FIG. 4.

### Electronic Document Views

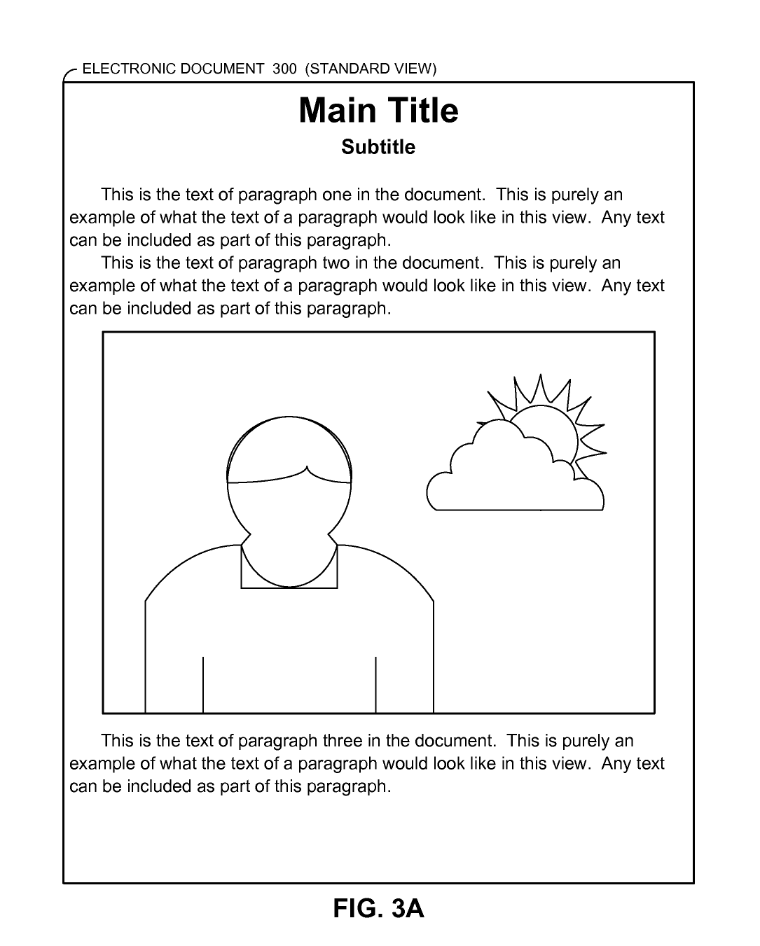

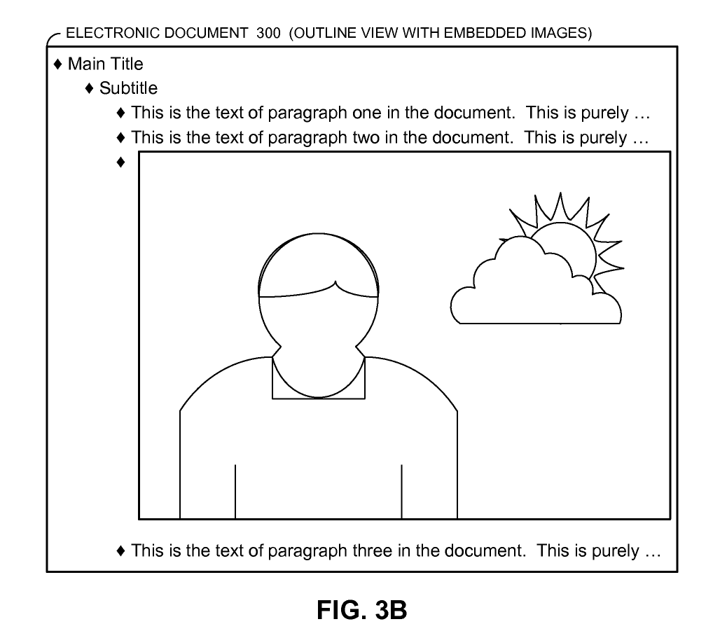

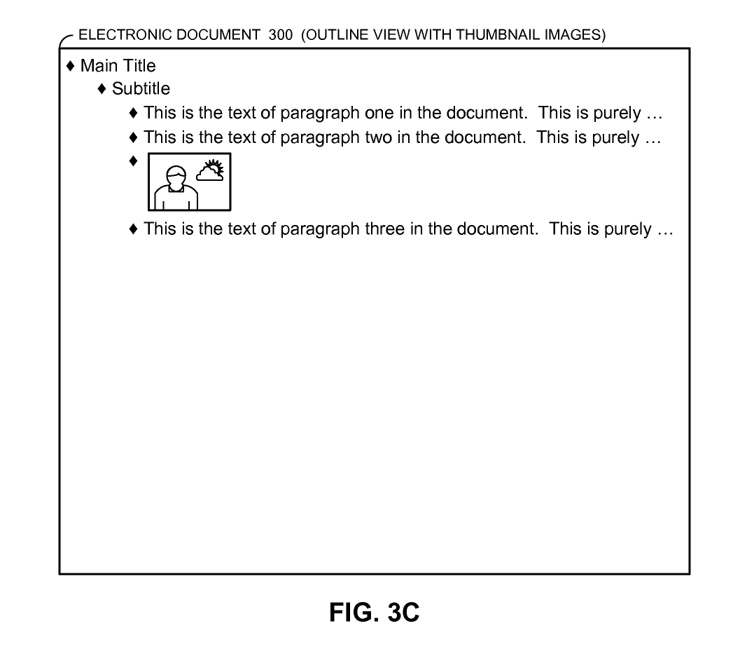

We now present a number of exemplary document views. FIG. 3A illustrates an electronic document 300 in a standard view in accordance with an embodiment of the present invention. FIG. 3B illustrates electronic document 300 in an outline view with embedded images in accordance with an embodiment of the present invention. FIG. 3C illustrates electronic document 300 in an outline view with thumbnail images in accordance with an embodiment of the present invention.

### Displaying Images in an Outline View

FIG. 4 presents a flow chart illustrating the process of displaying an image in an electronic document 300 while displaying electronic document 300 in an outline view in accordance with an embodiment of the present invention.

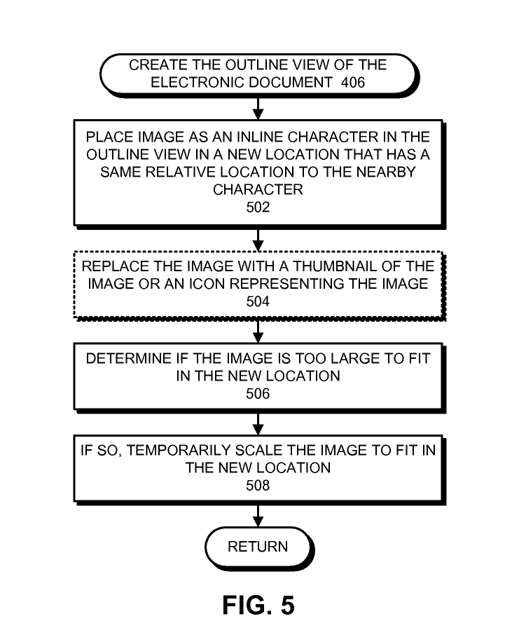

During operation, receiving mechanism 202 receives a command from a user 120 to view an electronic document 300 in an outline view (operation 402). In response to this command, determination mechanism 204 determines a location of an image in electronic document 300 relative to a nearby character in electronic document 300 (operation 404) by treating the image as if the image were an inline character. Next, outline-creation mechanism 206 creates the outline view of electronic document 300 (operation 406). This operation is described in more detail below in the description of FIG. 5.

Note that the absolute location of the image may change, but the relative position of the image to the content should remain the same. Next, display mechanism 210 displays the outline view of electronic document 300 (operation 408). Finally, in some embodiments of the present invention, receiving mechanism 202 receives a second command from user 120 to resize the image while electronic document 300 is displayed in the outline view (operation 410) In response to this second command, image-resizing mechanism 208 resizes the image in response to the second command (operation 412).

### Creating the Outline View

FIG. 5 presents a flow chart illustrating the process of creating an outline view of electronic document 300 in accordance with an embodiment of the present invention.

During operation, outline-creation mechanism 206 places the image as an inline character in the outline view in a new location that has a same relative location to the nearby character (operation 502) Note that in some embodiments, outline-creation mechanism 206 replaces the image with a thumbnail of the image or an icon representing the image (operation 504).

Finally, outline-creation mechanism 206 determines if the image is too large to fit in the new location (operation 506), and if so, temporarily scales the image to fit in the new location (operation 508).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed u:

1. A method for displaying images in an outline view of an electronic document, the method comprising:
receiving a command from a user to display an electronic document in an outline view;
determining a location of an image in the electronic document relative to a nearby character in the electronic document by treating the image as if the image were an inline character;
creating the outline view of the electronic document by:
placing the image as an inline character in the outline view in a new location that has a same relative location to the nearby character,
determining if the image is too large to fit in the new location, and
if so, temporarily scaling the image to fit in the new location.

2. The method of claim 1, wherein creating the outline view of the electronic document further comprises replacing the image with an icon representing the image.

3. The method of claim 1, wherein creating the outline view of the electronic document further comprises replacing the image with a thumbnail of the image.

4. The method of claim 1, further comprising:
receiving a second command from the user to resize the image while the electronic document is displayed in the outline view; and
in response to the second command, resizing the image.

5. The method of claim 4, wherein resizing the image involves resizing the image so that the new size of the image persists in other views of the electronic document.

6. The method of claim 1, wherein floating images are not displayed in the outline view, and wherein a floating image is an image that stays in a fixed position relative to a window displaying the electronic document, and has no fixed position relative to content in the electronic document.

7. The method of claim 1, further comprising:
determining if the image is configured to have text wrap around the image; and
if so, including enough of the text to wrap around the image in the outline view, and suppressing the display of the remaining text.

8. The method of claim 1, wherein an image can include one of:
a picture;
a drawing; and
a frame of an embedded video.

9. A computer-readable storage medium storing instructions that when executed by a computer cause the computer to perform a method for displaying images in an outline view of an electronic document, the method comprising:
receiving a command from a user to display an electronic document in an outline view;
determining a location of an image in the electronic document relative to a nearby character in the electronic document by treating the image as if the image were an inline character;
creating the outline view of the electronic document by:
placing the image as an inline character in the outline view in a new location that has a same relative location to the nearly character,
determining if the image is too large to fit in the new location, and
if so, temporarily scaling the image to fit in the new location.

10. The computer-readable storage medium of claim 9, wherein creating the outline view of the electronic document further comprises replacing the image with an icon representing the image.

11. The computer-readable storage medium of claim 9, wherein creating the outline view of the electronic document further comprises replacing the image with a thumbnail of the image.

12. The computer-readable storage medium of claim 9, wherein the method further comprises:
receiving a second command from the user to resize the image while the electronic document is displayed in the outline view; and
in response to the second command, resizing the image.

13. The computer-readable storage medium of claim 12, wherein resizing the image involves resizing the image so that the new size of the image persists in other views of the electronic document.

14. The computer-readable storage medium of claim 9, wherein floating images are not displayed in the outline view, and wherein a floating image is an image that stays in a fixed position relative to a window displaying the electronic document, and has no fixed position relative to content in the electronic document.

15. The computer-readable storage medium of claim 9, wherein the method further comprises:
determining if the image is configured to have text wrap around the image; and
if so, including enough of the text to wrap around the image in the outline view, and suppressing the display of the remaining text.

16. The computer-readable storage medium of claim 9, wherein an image can include one of:
a picture;
a drawing; and
a frame of an embedded video.

17. An apparatus configured for displaying images in an outline view of an electronic document, comprising:
a receiving mechanism configured to receive a command from a user to display an electronic document in an outline view;
a determination mechanism configured to determine a location of an image in the electronic document relative to a nearby character in the electronic document by treating the image as if the image were an inline character;
an outline-creation mechanism configured to create the outline view of the electronic document by:
placing the image as an inline character in the outline view in a new location that has a same relative location to the nearby character,
determining if the image is too large to fit in the new location,and
if so, temporarily scaling the image to fit in the new location.

18. The apparatus of claim 17, wherein the outline-creation mechanism is further configured to replace the image with an icon representing the image.

19. The apparatus of claim 17, wherein the outline-creation mechanism is further configured to replace the image with a thumbnail of the image.

20. The apparatus of claim 17:
wherein the receiving mechanism is further configured to receive a second command from the user to resize the image while the electronic document is displayed in the outline view; and
wherein the apparatus further comprises an image-resizing mechanism configured to resize the image in response to the second command.
